(19) United States
(12) Patent Application Publication
(10) Pub. No.: US 2025/0308780 A1
(43) Pub. Date: Oct. 2, 2025

(54) MULTILAYER CERAMIC ELECTRONIC DEVICE

(71) Applicant: TDK Corporation, Tokyo (JP)

(72) Inventors: Atsushi WATANABE, Tokyo (JP); Tomoyuki Tanabe, Tokyo (JP); Kazuhiro Okada, Tokyo (JP); Shizuku Ito, Tokyo (JP); Yasuhiro Okui, Tokyo (JP); Toshihiro Iguchi, Tokyo (JP)

(73) Assignee: TDK Corporation, Tokyo (JP)

(21) Appl. No.: 19/075,080

(22) Filed: Mar. 10, 2025

(30) Foreign Application Priority Data
Mar. 29, 2024 (JP) 2024-057736

(51) Int. Cl. H01G 4/12; H01G 4/30

(52) U.S. Cl. CPC H01G 4/1209; H01G 4/30

(57) ABSTRACT

A multilayer ceramic electronic device includes dielectric layers and internal electrode layers. The dielectric layers and the internal electrode layers are being laminated. The internal electrode layers include a first internal electrode layer located farthest out along a lamination direction. The dielectric layers include an external dielectric layer located outwards from the first internal electrode layer along the lamination direction. The external dielectric layer has a concentration gradient of Mn increasing from a vicinity of the first internal electrode layer outwards along the lamination direction.

### TECHNICAL FIELD

The present invention relates to a multilayer ceramic electronic device.

### BACKGROUND

Patent Document 1 discloses an invention related to a multilayer ceramic capacitor. Patent Document 1 specifically discloses that a boundary layer containing Mg and Mn being provided at a boundary between an outermost internal electrode and an outermost dielectric ceramic layer located outwards from the outermost internal electrode can mitigate or prevent entry of moisture into a ceramic multilayer body.
Patent Document 1: JP Patent Application Laid Open No. 2014-232896

### SUMMARY

It is an object of the present invention to provide a multilayer ceramic electronic device with good temperature characteristics and fewer thermal cracks.

To achieve the above object, a multilayer ceramic electronic device according to the present invention is
a multilayer ceramic electronic device including:
dielectric layers and internal electrode layers, the dielectric layers and the internal electrode layers being laminated,
wherein
the internal electrode layers include a first internal electrode layer located farthest out along a lamination direction;
the dielectric layers include an external dielectric layer located outwards from the first internal electrode layer along the lamination direction; and
the external dielectric layer has a concentration gradient of Mn increasing from a vicinity of the first internal electrode layer outwards along the lamination direction.

The external dielectric layer may have a thickness of 150 μm or more and 500 μm or less.

The external dielectric layer may include a portion away from the first internal electrode layer by not more than 100 μm; and the portion may have the concentration gradient.

The external dielectric layer may include a portion away from the first internal electrode layer by 100 μm or more, a portion away from the first internal electrode layer by 1 μm or more and 50 μm or less, and a portion away from the first internal electrode layer by 50 μm or more and 100 μm or less;

the portion away from the first internal electrode layer by 1 μm or more and 50 μm or less may have a Mn concentration that is 80% or more and 90% or less of a Mn concentration of the portion away from the first internal electrode layer by 100 μm or more; and the portion away from the first internal electrode layer by 50 μm or more and 100 μm or less may have a Mn concentration that is 90% or more and 100% or less of the Mn concentration of the portion away from the first internal electrode layer by 100 μm or more.

The first internal electrode layer may have a Mn concentration higher than that of other internal electrode layers.

The internal electrode layers may include a second internal electrode layer being located inwards from the first internal electrode layer and having a gap-corresponding portion;
the internal electrode layers may include a third internal electrode layer being located inwards from the second internal electrode layer and not having the gap-corresponding portion; and
C3<C2A<C1 may be satisfied, where
C1 denotes the Mn concentration of the first internal electrode layer,
C2A denotes a Mn concentration of the gap-corresponding portion of the second internal electrode layer, and
C3 denotes a Mn concentration of the third internal electrode layer.

C1/C3 may be 2.5 or more and 4.0 or less.

C2A/C2B may be 1.5 or more and 3.0 or less, where C2B denotes a Mn concentration of a portion of the second internal electrode layer other than the gap-corresponding portion.

C1/C2A may be 1.2 or more and 2.0 or less.

The dielectric layers may include an internal dielectric layer located inwards from the first internal electrode layer along the lamination direction; and the internal dielectric layer may have a thickness of 3.0 μm or more and 15 μm or less.

The number of the internal electrode layers may be 50 or more and 300 or less.

The dielectric layers may contain Ca, Sr, Zr, Ti, and O.

### BRIEF DESCRIPTION OF THE DRAWING(S)

FIG. 1 is a schematic sectional view of a multilayer ceramic capacitor according to one embodiment of the present invention.

FIG. 2 is a schematic sectional view of a multilayer ceramic capacitor according to one embodiment of the present invention.

FIG. 3 is a schematic sectional view of a multilayer ceramic capacitor according to one embodiment of the present invention.

FIG. 4 is a graph showing a relationship between the distance from a first internal electrode layer and the intensity of a characteristic X-ray of Mn.

FIG. 5 is a graph showing a relationship between the distance from a first internal electrode layer and the intensity of a characteristic X-ray of Mn.

FIG. 6 is a schematic partial sectional view of the multilayer ceramic capacitor according to the one embodiment of the present invention.

FIG. 7 is a schematic partial sectional view of the multilayer ceramic capacitor according to the one embodiment of the present invention.

FIG. 8 is a schematic partial sectional view of the multilayer ceramic capacitor according to the one embodiment of the present invention.

FIG. 9 is a schematic view of one example arrangement of dielectric layer sheets.

FIG. 10 is a schematic view of one example arrangement of dielectric layer sheets.

### DETAILED DESCRIPTION

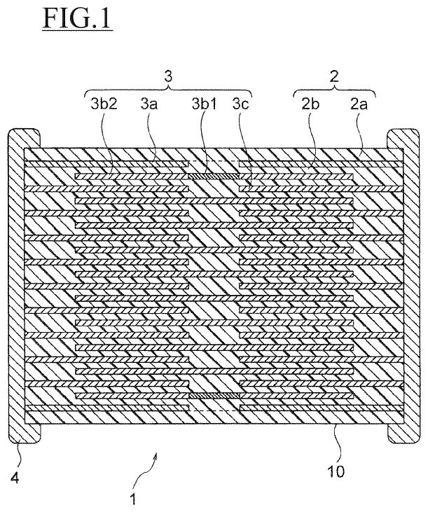

Hereinafter, the present invention is described with reference to a specific embodiment. FIG. 1 shows a multilayer ceramic capacitor 1 as an example multilayer ceramic electronic device according to the present embodiment. The multilayer ceramic capacitor 1 includes an element body 10, in which dielectric layers 2 and internal electrode layers 3 are alternately laminated. At both ends of this element body 10, a pair of external electrodes 4 is provided.

In the element body 10, pairs of the internal electrode layers 3 electrically connected to the respective external electrodes 4 shown in FIG. 1 and the internal electrode layers 3 electrically connected to neither of the external electrodes 4 shown in FIG. 1 are alternately arranged along the lamination direction (vertical direction of FIG. 1).

The element body 10 may have any shape but normally has a rectangular parallelepiped shape. The element body 10 may have any dimensions. The dimensions are appropriately determined according to uses.

The dielectric layers 2 may have any composition. The dielectric layers 2 may be composed of, for example, a dielectric ceramic composition. The composition of the dielectric layers 2 is not limited. The dielectric layers 2 may, for example, mainly contain Ca, Sr, Zr, Ti, and O or contain a perovskite compound containing Ca and Sr as A-site elements and Zr and Ti as B-site elements. A perovskite compound is a compound having a perovskite-type crystal structure represented by a formula ABO₃ (where A includes A-site elements and B includes B-site elements). In a situation where the dielectric layers 2 mainly contain Ca, Sr, Zr, Ti, and O, a technique described later enhances effects of maintaining suitable temperature characteristics and preventing or reducing thermal cracks.

The situation where the dielectric layers 2 mainly contain Ca, Sr, Zr, Ti, and O indicates a situation where Ca, Sr, Zr, Ti, and O constitute a total of 90 at % or more of the dielectric layers 2.

In a situation where the dielectric layers 2 contain a perovskite compound containing Ca and Sr as A-site elements and Zr and Ti as B-site elements, the ratio of Ca and Sr to all A-site elements of the perovskite compound may be 50 at % or more. The ratio of Zr and Ti to all B-site elements of the perovskite compound may be 90 at % or more.

Note that, in a situation where the ratio of Ca and Sr to all A-site elements of the perovskite compound is less than 50 at %, or particularly in a situation where much Ba is contained as an A-site element, the effects, produced by the technique described later, of maintaining suitable temperature characteristics and preventing or reducing thermal cracks are readily reduced.

Other than the above perovskite compound, the dielectric layers 2 may contain, for example, SiO₂ and/or Al₂O₃. Specifically, with respect to 100 parts by mol B-site elements of the perovskite compound, the dielectric layers 2 may contain 0 parts by mol or more and 4.0 parts by mol or less Si and/or 0 parts by mol or more and 2.0 parts by mol or less Al.

Among the dielectric layers 2, those located outwards from first internal electrode layers 3a described later along the lamination direction are defined as external dielectric layers 2a, and those located inwards from the first internal electrode layers 3a described later along the lamination direction are defined as internal dielectric layers 2b.

The external dielectric layers 2a contain Mn. The external dielectric layers 2a have a Mn concentration gradient increasing from the vicinity of the corresponding first internal electrode layer 3a outwards along the lamination direction. The presence of the above concentration gradient enables good temperature characteristics to be maintained and thermal cracks to be prevented or reduced.

The above concentration gradient may be anywhere in the external dielectric layers 2a.

The above concentration gradient may be present at, for example, a portion away from the first internal electrode layer 3a by not more than 100 μm.

More specifically, the above concentration gradient may be deemed present when an average Mn concentration of a portion away from the first internal electrode layer 3a by 1 μm or more and 50 μm or less is lower than an average Mn concentration of a portion away from the first internal electrode layer 3a by 50 μm or more and 100 μm or less.

In the external dielectric layers 2a, the average Mn concentration of the portion away from the first internal electrode layer 3a by 1 μm or more and 50 μm or less may be 50% or more and 90% or less of an average Mn concentration of a portion away from the first internal electrode layer 3a by 100 μm or more; and the average Mn concentration of the portion away from the first internal electrode layer 3a by 50 μm or more and 100 μm or less may be 80% or more and 110% or less of the average Mn concentration of the portion away from the first internal electrode layer 3a by 100 μm or more.

In the external dielectric layers 2a, the average Mn concentration of the portion away from the first internal electrode layer 3a by 1 μm or more and 50 μm or less may be 80% or more and 90% or less of the average Mn concentration of the portion away from the first internal electrode layer 3a by 100 μm or more; and the average Mn concentration of the portion away from the first internal electrode layer 3a by 50 μm or more and 100 μm or less may be 90% or more and 100% or less of the average Mn concentration of the portion away from the first internal electrode layer 3a by 100 μm or more.

When the Mn concentration distribution is within the above range, thermal cracks, particularly those at interfaces between the external dielectric layers 2a and the first internal electrode layers 3a or at interfaces between the external dielectric layers 2a and the external electrodes 4, are readily prevented or reduced.

Methods of checking the presence or absence of the above concentration gradient and the Mn concentration distribution include a method of measuring the intensity of a characteristic X-ray of Mn using SEM-EDS or STEM-EDS.

The intensity of the characteristic X-ray of Mn is in proportion to the Mn concentration. Thus, in a line analysis of the intensity of the characteristic X-ray of Mn along the lamination direction from the first internal electrode layer 3a towards the corresponding external dielectric layer 2a, the presence of a portion with an increasing intensity of the characteristic X-ray of Mn as the distance from the first internal electrode layer 3a increases can indicate the presence of the above concentration gradient.

In the above line analysis, distances between portions subject to measurement of the characteristic X-ray are sufficiently short. Specifically, the distances are 2 μm or less.

Alternatively, the above concentration gradient may be deemed present when an average intensity of the characteristic X-ray of Mn of the portion away from the first internal electrode layer 3a by 1 μm or more and 50 μm or less is lower than an average intensity of the characteristic X-ray of Mn of the portion away from the first internal electrode layer 3a by 50 μm or more and 100 μm or less.

The average intensity of the characteristic X-ray of Mn of the portion away from the first internal electrode layer 3a by 1 μm or more and 50 μm or less may be 80% or more and 90% or less of an average intensity of the characteristic X-ray of Mn of the portion away from the first internal electrode layer 3a by 100 μm or more; and the average intensity of the characteristic X-ray of Mn of the portion away from the first internal electrode layer 3a by 50 μm or more and 100 μm or less may be 90% or more and 100% or less of the average intensity of the characteristic X-ray of Mn of the portion away from the first internal electrode layer 3a by 100 μm or more. In this situation, the average Mn concentration of the portion away from the first internal electrode layer 3a by 1 μm or more and 50 μm or less is 80% or more and 90% or less of the average Mn concentration of the portion away from the first internal electrode layer 3a by 100 μm or more; and the average Mn concentration of the portion away from the first internal electrode layer 3a by 50 μm or more and 100 μm or less is 90% or more and 100% or less of the average Mn concentration of the portion away from the first internal electrode layer 3a by 100 μm or more.

In the calculation of the average intensity of the characteristic X-ray of Mn of the portion away from the first internal electrode layer 3a by 100 μm or more, this portion is entirely subject to calculation of the average intensity of the characteristic X-ray of Mn when the external dielectric layer 2a has a thickness of less than 200 μm.

When the external dielectric layer 2a has a thickness of 200 μm or more, an average intensity of the characteristic X-ray of Mn of a portion away from the first internal electrode layer 3a by 100 μm or more and 200 μm or less may be deemed to be the average intensity of the characteristic X-ray of Mn of the portion away from the first internal electrode layer 3a by 100 μm or more.

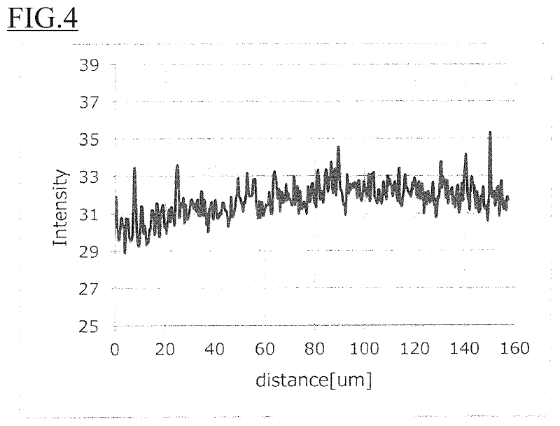

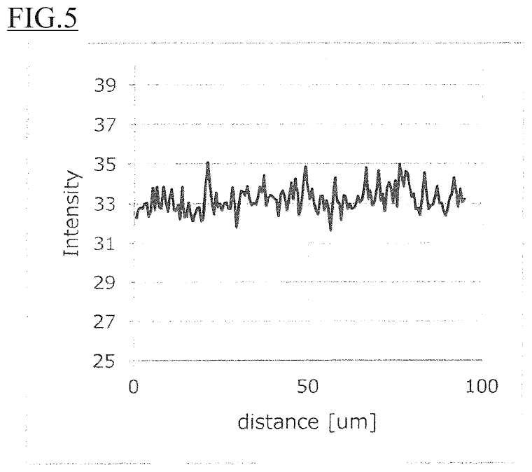

FIGS. 4 and 5 are graphs each having a horizontal axis representing the distance from the first internal electrode layer 3a and a vertical axis representing the intensity of the characteristic X-ray of Mn. FIG. 4 shows a situation where the average intensity of the characteristic X-ray of Mn of the portion away from the first internal electrode layer 3a by 1 μm or more and 50 μm or less is lower than the average intensity of the characteristic X-ray of Mn of the portion away from the first internal electrode layer 3a by 50 μm or more and 100 μm or less. FIG. 5 shows a situation where the average intensity of the characteristic X-ray of Mn of the portion away from the first internal electrode layer 3a by 1 μm or more and 50 μm or less is the same as the average intensity of the characteristic X-ray of Mn of the portion away from the first internal electrode layer 3a by 50 μm or more and 100 μm or less.

It is assumed that a reason why the presence of the above concentration gradient in the external dielectric layers 2a can prevent or reduce thermal cracks is that the presence of the concentration gradient prevents or mitigates sintering of the external dielectric layers 2a to reduce the shrinkage factor of the external dielectric layers 2a due to sintering.

Note that, in a situation where there is a Mn concentration gradient decreasing from the vicinity of the first internal electrode layer 3a outwards along the lamination direction, thermal cracks are readily generated.

The external dielectric layers 2a may have any thickness. The thickness can be freely determined according to desired characteristics, uses, etc. The thickness may, for example, exceed 50 μm and be 800 μm or less, or be 150 μm or more and 500 μm or less. The thicker the external dielectric layers 2a, the more readily thermal cracks are generated. In contrast, the thinner the external dielectric layers 2a, the less the likelihood of thermal cracks become dependent on the presence or absence of the above concentration gradient.

The internal dielectric layers 2b may have any thickness (interlayer thickness) per layer. The thickness can be freely determined according to desired characteristics, uses, etc. The thickness may be, for example, 1.0 μm or more and 20 μm or less, or 3.0 μm or more and 15 μm or less. The thicker the internal dielectric layers 2b, the less the likelihood of thermal cracks become dependent on the presence or absence of the above concentration gradient. The thinner the internal dielectric layers 2b, the more readily thermal cracks are generated.

Some internal electrode layers 3 are laminated so that their end surfaces are exposed to surfaces of two ends of the element body 10 facing each other.

Among the internal electrode layers 3, those that are located farthest out along the lamination direction are defined as the first internal electrode layers 3a; those that are located inwards from the first internal electrode layers 3a and have a gap-corresponding portion described later are defined as second internal electrode layers; and those that are located inwards from the second internal electrode layers and have no gap-corresponding portion described later are defined as third internal electrode layers 3c.

The gap-corresponding portion is where, in the internal electrode layers 3 other than the first internal electrode layers 3a, no other internal electrode layer exists outwards from the gap-corresponding portion along the lamination direction.

The gap-corresponding portion is a portion having a length of 10 μm or more in the thickness direction of the external electrodes 4 (horizontal direction of FIG. 1). In other words, a portion having a length of less than 10 μm in the thickness direction of the external electrodes 4 is not deemed to be a gap-corresponding portion even if no other internal electrode layer exists outwards from that portion along the lamination direction.

As shown in FIG. 1, each of the second internal electrode layers is composed of the gap-corresponding portion 3b1 and portions 3b2 other than the gap-corresponding portion.

The percentage of the length of the gap-corresponding portion 3b1 out of the length of the second internal electrode layer in the horizontal direction of FIG. 1 (the total length of the gap-corresponding portion 3b1 and the portions 3b2 other than the gap-corresponding portion) is not limited. The percentage may be, for example, 2.5% or more and 20% or less.

The internal electrode layers 3 contain a conductive material having a main component composed of metal. The metal is not limited and is, for example, a conductive material known as metal (e.g., Pd, a Pd based alloy, Pt, a Pt based alloy, Ni, a Ni based alloy, Cu, and a Cu based alloy).

Some of the internal electrode layers 3, such as the first internal electrode layers 3a, may contain Mn. The first internal electrode layers 3a may have a Mn concentration higher than that of other internal electrode layers.

The high Mn concentration of the first internal electrode layers 3a readily reduces the linear thermal expansion coefficient of the first internal electrode layers 3a and readily reduces a difference in the linear thermal expansion coefficients between the external dielectric layers 2a and the first internal electrode layers 3a. It is thus assumed that thermal cracks are less readily generated.

Relatively increasing the Mn concentration of the first internal electrode layers readily improves the temperature characteristics of the multilayer ceramic capacitor 1 more than uniformly increasing the Mn concentration of all the internal electrode layers does.

In a situation where all the internal electrode layers have a uniformly low Mn concentration, thermal cracks are readily generated; whereas in a situation where all the internal electrode layers have a uniformly high Mn concentration, it is difficult to maintain good temperature characteristics.

The first internal electrode layers 3a may have any Mn concentration. The Mn concentration may be, for example, 0.1 wt % or more and 3.0 wt % or less.

C3<C2A<C1 may be satisfied, where C1 denotes the Mn concentration of the first internal electrode layers 3a, C2A denotes the Mn concentration of the gap-corresponding portions 3b1 of the second internal electrode layers, C2B denotes the Mn concentration of the portions 3b2 other than the gap-corresponding portions of the second internal electrode layers, and C3 denotes the Mn concentration of the third internal electrode layers 3c.

Moreover, C1/C3 may be 2.5 or more and 4.0 or less. C2A/C2B may be 1.5 or more and 3.0 or less. C1/C2A may be 1.2 or more and 2.0 or less. Note that, while C2B/C3 is not limited, C2B/C3 may be 0.9 or more and 1.1 or less or may be 1.0. While C2A/C3 is not limited, C2A/C3 may be 1.1 or more and less than 4.0.

Satisfaction of the above relationships by the Mn concentrations of the internal electrode layers makes it difficult for thermal cracks to be generated and makes it easy to maintain good temperature characteristics. Note that, in a situation where C1/C3, C2A/C2B, and/or C1/C2A is or are large, temperature characteristics tend to be readily reduced.

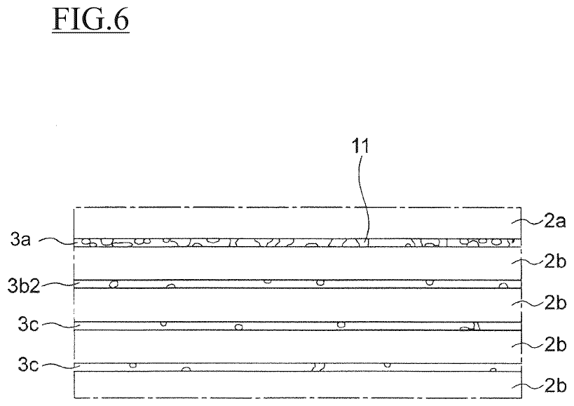

FIGS. 6 to 8 are schematic views showing respective parts of FIG. 1. As shown in FIGS. 6 to 8, the internal electrode layers may include Mn segregates 11, which have a higher Mn concentration than that of the surroundings.

Inclusion of the Mn segregates 11 in the internal electrode layers can be checked by creating a Mn elemental mapping image of a section of the multilayer ceramic capacitor 1 using SEM-EDS, STEM-EDS, or the like.

FIG. 6 is a schematic view showing a portion including one first internal electrode layer 3a, the portion 3b2 other than the gap-corresponding portion of one second internal electrode layer, and the third internal electrode layers 3c. It is found that many of the Mn segregates 11 are included in the first internal electrode layer 3a. It is also found that the portion 3b2 other than the gap-corresponding portion of the second internal electrode layer and the third internal electrode layers 3c include the Mn segregates 11 substantially equivalently.

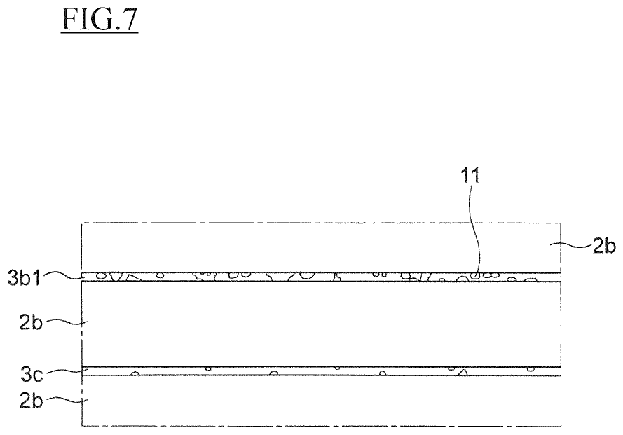

FIG. 7 is a schematic view showing a portion including the gap-corresponding portion 3b1 of the second internal electrode layer and one third internal electrode layer 3c. It is found that many of the Mn segregates 11 are included in the gap-corresponding portion 3b1 of the second internal electrode layer.

According to FIGS. 6 and 7, it is found that the first internal electrode layer 3a has a higher percentage of the Mn segregates 11 than that of the gap-corresponding portion of the second internal electrode layer.

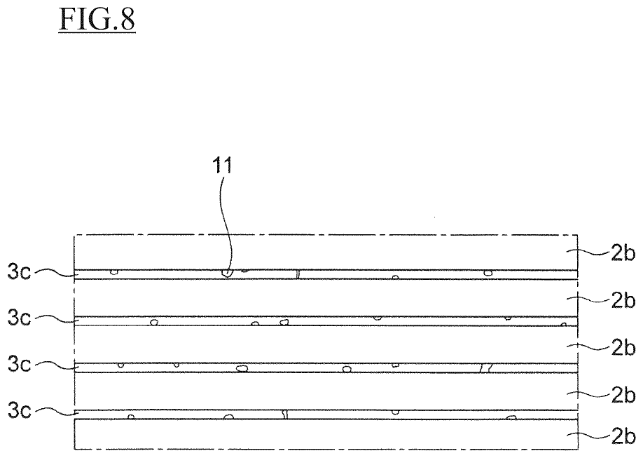

FIG. 8 is a schematic view showing a portion including multiple third internal electrode layers 3c. It is found that the third internal electrode layers 3c include the Mn segregates 11 substantially equivalently.

Any method of measuring C1, C2A, C2B, and C3 may be used. Examples of such methods include a method of measuring the intensity of the characteristic X-ray of Mn using SEM-EDS or STEM-EDS.

The intensity of the characteristic X-ray of Mn is in proportion to the Mn concentration. Thus, satisfaction of C3<C2A<C1 can be checked by carrying out a line analysis of the intensity of the characteristic X-ray of Mn inside the internal electrode layers along the thickness direction of the external electrodes 4 (horizontal direction of FIG. 1) and averaging the measurement. Moreover, C1/C3, C2A/C2B, and C1/C2A can be calculated.

In the above line analysis, distances between portions subject to measurement of the characteristic X-ray are sufficiently short. Specifically, the distances are 2 μm or less. In order to check C1, C2A, C2B, and C3, the line analysis is carried out for at least a length of 30 μm or more.

The internal electrode layers 3 may contain about 0.1 mass % or less various trace components, such as P. To form the internal electrode layers 3, a commercially available electrode paste may be used. The thickness of the internal electrode layers 3 is appropriately determined according to uses or the like.

The number of the internal electrode layers 3 is not limited. The number may be 40 or more and 400 or less or may be 50 or more and 300 or less. The larger the number of the internal electrode layers 3, the more readily thermal cracks are generated. The smaller the number of the internal electrode layers 3, the less the likelihood of thermal cracks become dependent on the presence or absence of the above concentration gradient.

The external electrodes 4 may contain any conductive material. For example, a known conductive material (e.g., Ni, Cu, Sn, Ag, Pd, Pt, Au, their alloys, and a conductive resin) is used. The thickness of the external electrodes 4 is appropriately determined according to uses or the like.

An example method of manufacturing the multilayer ceramic capacitor 1 shown in FIG. 1 is described next.

First, steps of manufacturing the element body 10 are described. In the steps of manufacturing the element body 10, dielectric pastes to be the dielectric layers 2 after firing and an internal electrode paste to be the internal electrode layers 3 after firing are prepared.

Each of the dielectric pastes is prepared using, for example, the following method. First, dielectric raw materials are uniformly mixed using wet-mixing or the like and are dried.

The dielectric raw materials may include oxides of metal elements or compounds (e.g., carbonates) that become oxides of metal elements by a firing treatment. Then, the resultant mixture is subject to a heat treatment under predetermined conditions to give a calcined powder. Then, to the resultant calcined powder, a known organic vehicle or a known water based vehicle is added; and this mixture is kneaded to give the dielectric paste. The dielectric paste may contain additives selected from various dispersants, plasticizers, dielectrics, subcomponent compounds, glass frit, and the like as necessary.

To provide the external dielectric layers 2a with the Mn concentration gradient and to provide the internal electrode layers with the Mn segregates as necessary, multiple types of dielectric pastes having different Mn contents are prepared. The Mn content is adjusted specifically by controlling the amount of a Mn oxide powder or a powder of a compound that becomes the Mn oxide by a firing treatment.

In contrast, the internal electrode paste is provided by kneading a conductive metal or a conductive powder (preferably a Ni powder or a Ni alloy powder) composed of an alloy of the conductive metal. To provide the internal electrode layers with the Mn segregates as necessary, a Mn oxide powder or a powder of a compound that becomes the Mn oxide by a firing treatment may be appropriately added. Also, it may be that multiple types of internal electrode pastes having different Mn contents are prepared.

Note that the internal electrode paste may contain a ceramic powder as an inhibitor as necessary. The inhibitor prevents or mitigates sintering of the conductive powder in a firing process.

Then, the dielectric pastes are turned into sheets using, for example, a doctor blade method to give green sheets.

In the following description, the multiple dielectric pastes are used to give Mn-rich sheets 21, Mn-adequate sheets 22, and no-Mn sheets 23, which are used as the green sheets.

To the respective green sheets, the internal electrode paste is applied in a predetermined pattern using a printing method (e.g., screen printing) or a transfer method to form internal electrode patterns 31. The green sheets with the internal electrode patterns 31 are laminated, and this laminate is pressed in the lamination direction to give a green chip.

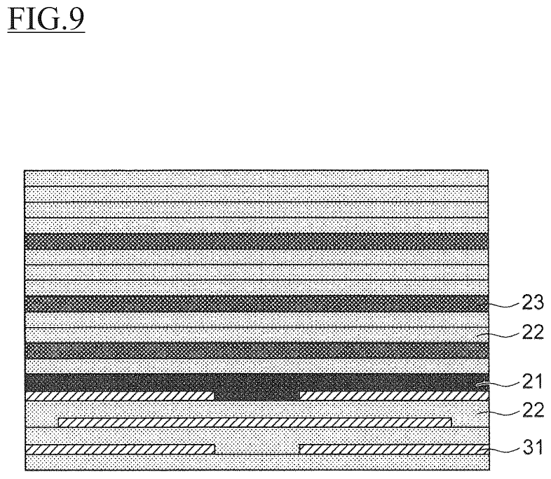

At this time, the green sheets are laminated as shown in FIG. 9. Specifically, the Mn-rich sheets 21 are disposed so as to be in contact with the internal electrode patterns 31 that eventually become the first internal electrode layers 3a. The Mn-adequate sheets 22 are disposed where to eventually become the internal dielectric layers 2b. Outwards from the Mn-rich sheets 21, the Mn-adequate sheets 22 and the no-Mn sheets 23 are appropriately disposed.

At this time, as shown in FIG. 9, more no-Mn sheets 23 are disposed closer to the internal electrode patterns 31. This can provide the above Mn concentration gradient in the external dielectric layers 2a.

Arrangement of the Mn-rich sheets 21 outwards from the internal electrode patterns that eventually become the first internal electrode layers 3a diffuses much Mn contained in the Mn-rich sheets into the dielectric. Mn is thus incorporated into the internal electrodes to form the Mn segregates. Consequently, a state where C1 is the highest, C2A is the second highest, and C2B and C3 are low can be generated.

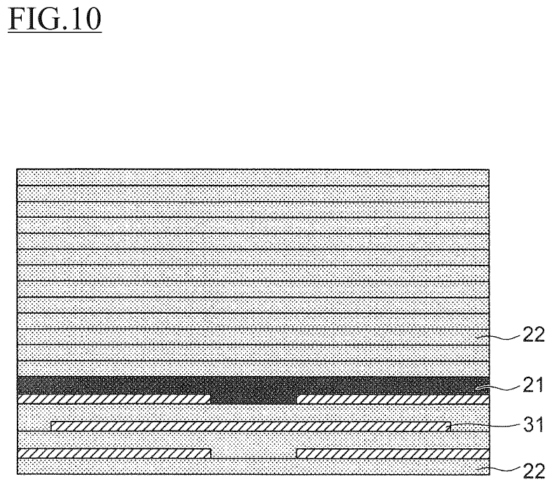

In contrast, if a green chip is manufactured without using the no-Mn sheets 23 as shown in FIG. 10, it is difficult to provide the external dielectric layers 2a with the above Mn concentration gradient.

The resultant green chip may be subject to a binder removal treatment as necessary. Conditions of the binder removal treatment are known conditions. For example, the holding temperature may be 200° C. or more and 900° C. or less, and the holding time may be 1 hour or more and 48 hours or less. The binder removal atmosphere is also not limited.

After the binder removal treatment, the green chip is fired to give the element body 10. In the present embodiment, the firing atmosphere may be a reducing atmosphere with an oxygen partial pressure of 2.0×10⁻¹³ atm or more and 1.0×10⁻⁷ atm or less. Other firing conditions are known conditions. For example, the holding temperature may be 1100° C. or more and 1350° C. or less, and the holding time may be 0.5 hours or more and 5 hours or less.

After firing, an annealing treatment may be carried out as necessary. Conditions of the annealing treatment are not limited. For example, the holding temperature may be 500° C. or more and 1150° C. or less, and the holding time may be 0.5 hours or more and 20 hours or less. The oxygen partial pressure of the annealing atmosphere is, for example, 1.0×10⁻⁹ atm or more and 3.0×10⁻⁵ atm or less.

End surfaces of the resultant element body 10 obtained as above are polished as necessary. An external electrode paste is applied to the end surfaces, and the applied paste is baked to form the external electrodes 4. On surfaces of the external electrodes 4, a coating layer is formed by plating or the like as necessary. Any method of preparing the external electrode paste may be used. The external electrode paste may be prepared using a method similar to the method of preparing the internal electrode paste.

In this manner, the multilayer ceramic capacitor 1 according to the present embodiment is manufactured.

Although one embodiment of the present invention has been described above, the present invention is not limited to the above embodiment and can be variously modified without departing from the gist of the present invention.

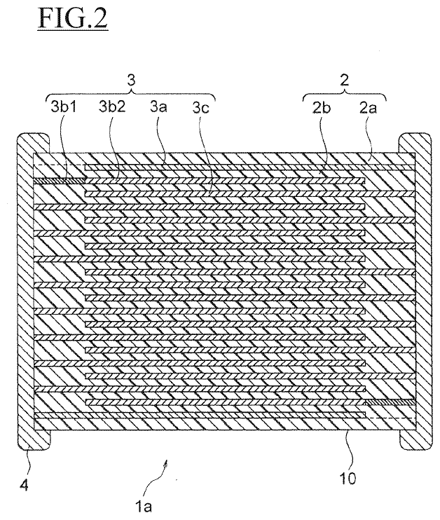

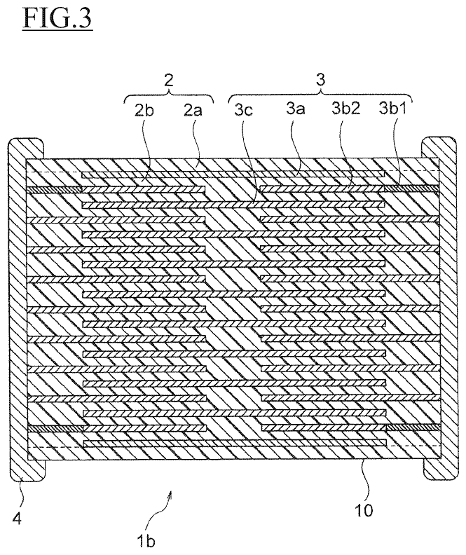

For example, as in a multilayer ceramic capacitor 1a shown in FIG. 2, at both ends of its element body 10, a pair of external electrodes 4 electrically connected to internal electrode layers 3 alternately arranged inside the element body 10 may be provided. Alternatively, as in a multilayer ceramic capacitor 1b shown in FIG. 3, it may be that no electrical conduction is provided between first internal electrode layers 3a and external electrodes 4.

In the present embodiment, the multilayer ceramic capacitor 1 exemplifies multilayer ceramic electronic devices; however, multilayer ceramic electronic devices of the present invention are not limited to multilayer ceramic capacitors.

### EXAMPLES

Hereinafter, the present invention is described based on more detailed examples; however, the present invention is not limited to these examples.

In the examples, multilayer ceramic capacitors 1 shown in FIG. 1 were manufactured using the following procedure.

First, three types of dielectric pastes having different Mn contents were prepared. These dielectric pastes were prepared using the same method.

A raw material powder (which may hereinafter be referred to as “main-component raw material powder”) of a perovskite compound contained as a main component of main phase grains was produced. Specifically, a raw material powder of a Ca oxide, a raw material powder of a Sr oxide, a raw material powder of a Zr oxide, and a raw material powder of a Ti oxide were prepared and were weighed to provide the perovskite compound (abbreviated to “CSZT” in Table 1) having a composition formula of (Ca_{0.70}Sr_{0.30}) (Zr_{0.96} Ti_{0.04})O₃. Note that a “raw material powder of a y oxide” denoted a powder of the y oxide and/or a powder of a compound that became the powder of the y oxide by a heat treatment. Then, the powders were dispersed in purified water, were dried, and were further subject to a heat treatment (holding temperature: 1200° C. to 1250° C., holding time: 0.5 hours to 5 hours) to give the main-component raw material powder having a specific surface area of about 5.0 m²/g measured using a BET adsorption method. The holding temperature and the holding time of the heat treatment were appropriately determined for each sample.

Separately, a MnCO₃ powder, a SiO₂ powder, and an Al₂O₃ powder were prepared. The powders were weighed so that the Si content was larger than the Al content in terms of atomicity. The MnCO₃ powder was prepared and weighed so that the dielectric paste for Mn-rich sheets had a Mn content of 4.0 to 10.0 parts by mol and that the dielectric paste for Mn-adequate sheets had a Mn content of 1.5 to 3.0 parts by mol. The powders were weighed so that the Mn-rich sheets and the Mn-adequate sheets had larger Mn contents than their Si contents in terms of atomicity.

The main-component raw material powder and the powders of the oxides of the additional elements were dispersed in purified water, were dried, and were further subject to a heat treatment to give a dielectric powder. The holding temperature was 400° C. The holding time was 0.5 to 5 hours. The holding time of the heat treatment was appropriately determined for each sample.

The dielectric powder and an organic vehicle were mixed to give each dielectric paste. With 100 parts by mass dielectric powder, 10 parts by mass polyvinyl butyral resin, 5 parts by mass dioctyl phthalate (DOP) as a plasticizer, and 100 parts by mass alcohol as a solvent were mixed using a ball mill; and the mixture was turned into a paste to give the dielectric paste.

A method of preparing an internal electrode paste was as follows. First, a Ni powder, terpineol, ethyl cellulose, and benzotriazole were prepared at a mass ratio of 44.6:52.0:3.0:0.4. They were kneaded using a triple-roll mill and were turned into a paste to give the internal electrode paste.

Then, using the above dielectric pastes and the internal electrode paste, green chips were manufactured with a sheet method. At this time, to provide external dielectric layers with a Mn concentration gradient, dielectric layer sheets were arranged as shown in FIG. 9. To not to provide the external dielectric layers with the Mn concentration gradient, no-Mn sheets shown in FIG. 9 were entirely replaced with the Mn-adequate sheets as shown in FIG. 10.

The green chips were subject to a binder removal treatment, a firing treatment, and an annealing treatment to give element bodies 10 having a rectangular parallelepiped shape with a dimension of 3.2 mm×2.5 mm in a plane perpendicular to the lamination direction. Note that 3.2 mm was the horizontal dimension of FIG. 1. The length in the lamination direction depended on the number of internal dielectric layers, the average thickness of the internal dielectric layers, and the thickness of the external dielectric layers described later. The holding temperature of the firing treatment was 1200° C. The holding time of the firing treatment was 2.0 hours. The firing atmosphere was a reducing atmosphere having an oxygen partial pressure of 2.0×10⁻¹³ atm or more and 1.0×10⁻⁷ atm or less. The number of the internal dielectric layers, the average thickness of the internal dielectric layers, and the thickness of the external dielectric layers of the element bodies 10 were as shown in the table.

Then, on outer surfaces of the above element bodies 10, a baked electrode layer containing Cu, a Ni plating layer, and a Sn plating layer were formed in the order mentioned to form external electrodes 4. Thus, the multilayer ceramic capacitors 1 were obtained.

### (Composition of Dielectric Ceramic Composition)

With regard to the composition of the dielectric ceramic composition, a composition analysis of the internal dielectric layers was carried out using ICP optical emission spectroscopy. It was confirmed that the perovskite compound contained in the internal dielectric layers had the above composition and had the additional element contents corresponding to those of the dielectric paste for the Mn-adequate sheets.

### (Mn Concentration Gradient)

With regard to the presence or absence of the Mn concentration gradient, a line analysis was carried out in a section along a direction shown in FIG. 1, i.e., a section parallel to the lamination direction and to the thickness direction of the external electrodes, for a length of 200 μm from a first internal electrode layer outwards along the lamination direction using STEM-EDS to measure the intensity of a characteristic X-ray of Mn. An average intensity in a range of 1 μm to 50 μm, an average intensity in a range of 50 μm to 100 μm, and an average intensity in a range of 100 μm to 200 μm were measured. Because the intensity of the characteristic X-ray of Mn and the Mn concentration were in proportion, ratios of the average concentrations were calculated. The presence or absence of the Mn concentration gradient was checked as well. The table shows the results.

### (Mn Concentration of Internal Electrode Layers and Presence or Absence of Mn Segregates)

With regard to the Mn concentration of the internal electrode layers, a line analysis of the internal electrode layers was carried out along the direction perpendicular to the lamination direction in the section along the direction shown in FIG. 1 to measure the intensity of the characteristic X-ray of Mn. An average intensity of the first internal electrode layer, an average intensity of a gap-corresponding portion of a second internal electrode layer, an average intensity of a portion other than the gap-corresponding portion of the second internal electrode layer, and an average intensity of a third internal electrode layer were measured. Because the intensity of the characteristic X-ray of Mn and the Mn concentration were in proportion, C1/C3, C2A/C2B, and C1/C2A were calculated. Moreover, a Mn mapping image including the internal dielectric layers was created using STEM-EDS, and this Mn mapping image was observed to check the percentage of the Mn segregates. With regard to the percentage of the Mn segregates, Table 1 shows whether the percentage of the Mn segregates of the first internal electrode layer was higher than or equivalent to the percentage of the Mn segregates of the third internal electrode layer.

### (Thermal Crack Test)

Sixty multilayer ceramic capacitors per sample number were immersed in a 400° C. solder bath for 3 seconds and were extracted. Each multilayer ceramic capacitor was checked for generation of a thermal crack using an optical microscope at a magnification of ×10. The number ratio of multilayer ceramic capacitors with a thermal crack was evaluated. The table shows the results. A thermal crack occurrence rate of 10/60 or less was deemed good. A thermal crack occurrence rate of 5/60 or less was deemed better. A thermal crack occurrence rate of less than 1/60, i.e., 0/60 in the present examples, was deemed best.

### (Temperature Characteristics)

A capacitance temperature coefficient τC (unit: ppm/° C.) was measured to evaluate the temperature characteristics of the multilayer ceramic capacitors 1. Specifically, at 25° C. and at 125° C., a signal with a frequency of 1 kHz and an input signal level (measurement voltage) of 1 Vrms was input to the multilayer ceramic capacitors to measure the capacitance at each temperature. Using capacitance C25 at 25° C. and capacitance C125 at 125° C., the capacitance temperature coefficient τC was calculated with the following formula.

$$τ C = \{ ( C 125 - C 25 ) / C 25 \} \times \{ 1 / ( 125 - 25 ) \}$$

Ten multilayer ceramic capacitors 1 per sample number were subject to measurement of their capacitance temperature coefficients τC, and they were averaged. The temperature characteristics were deemed good when the average capacitance temperature coefficient τC was −15 ppm/° C. or more and +15 ppm/° C. or less, fair when the average capacitance temperature coefficient τC was −20 ppm/° C. or more and less than −15 ppm/° C. or was above +15 ppm/° C. and +20 ppm/° C. or less, or poor when the average capacitance temperature coefficient τC was less than −20 ppm/° C. or above +20 ppm/° C. Note that, in this experiment, there were no cases where the temperature characteristics were poor.

TABLE 1

| | | | | | Percentage | | | | | | | | |
|---|---|---|---|---|---|---|---|---|---|---|---|---|---|
| | | Mn concentration gradient | | | of Mn | | | | | | Number | | |
| | | | Average | | segregate | | | | External | Internal | of | | |
| | | | intensity | | in first | Mn concentration | | | dielectric | dielectric | internal | Crack | |
| | Dielectric | Present | 1 to | 50 to | internal | ratio | | | layer | layer | electrode | occur- | Temperature |
| Sample | layer | or | 50 | 100 | electrode | C1/ | C1/ | C2A/ | thickness | thickness | layer | rence | characteristics |
| No. | material | absent | um | um | layer | C3 | C2A | C2B | um | um | Number | rate | Evaluation |
| Example 1 | CSZT | Present | 83 | 95 | Higher | 5.0 | 2.5 | 3.2 | 300 | 8 | 200 | 0/60 | Fair |
| Example 2 | CSZT | Present | 83 | 93 | Higher | 4.0 | 2.0 | 3.0 | 300 | 8 | 200 | 0/60 | Good |
| Example 3 | CSZT | Present | 87 | 97 | Higher | 3.2 | 1.4 | 2.3 | 300 | 8 | 200 | 0/60 | Good |
| Example 4 | CSZT | Present | 82 | 93 | Higher | 2.5 | 1.2 | 1.5 | 300 | 8 | 200 | 0/60 | Good |
| Example 5 | CSZT | Present | 85 | 92 | Higher | 2.1 | 1.1 | 1.3 | 300 | 8 | 200 | 2/60 | Good |
| Example 6 | CSZT | Present | 88 | 97 | Equivalent | 1.0 | 1.0 | 1.0 | 300 | 8 | 200 | 7/60 | Good |
| Example 7 | CSZT | Present | 86 | 97 | Higher | 3.2 | 1.4 | 2.3 | 150 | 8 | 200 | 0/60 | Good |
| Example 3 | CSZT | Present | 87 | 97 | Higher | 3.2 | 1.4 | 2.3 | 300 | 8 | 200 | 0/60 | Good |
| Example 8 | CSZT | Present | 85 | 96 | Higher | 3.2 | 1.4 | 2.3 | 500 | 8 | 200 | 0/60 | Good |
| Example 9 | CSZT | Present | 89 | 95 | Higher | 3.2 | 1.4 | 2.3 | 550 | 8 | 200 | 4/60 | Good |
| Example 10 | CSZT | Present | 88 | 96 | Higher | 3.2 | 1.4 | 2.3 | 300 | 3 | 200 | 0/60 | Good |
| Example 3 | CSZT | Present | 87 | 97 | Higher | 3.2 | 1.4 | 2.3 | 300 | 8 | 200 | 0/60 | Good |
| Example 11 | CSZT | Present | 88 | 95 | Higher | 3.2 | 1.4 | 2.3 | 300 | 15 | 200 | 0/60 | Good |
| Example 12 | CSZT | Present | 87 | 93 | Higher | 3.2 | 1.4 | 2.3 | 300 | 8 | 50 | 0/60 | Good |
| Example 3 | CSZT | Present | 87 | 97 | Higher | 3.2 | 1.4 | 2.3 | 300 | 8 | 200 | 0/60 | Good |
| Example 13 | CSZT | Present | 84 | 95 | Higher | 3.2 | 1.4 | 2.3 | 300 | 8 | 300 | 0/60 | Good |
| Example 14 | CSZT | Present | 74 | 96 | Higher | 3.2 | 1.4 | 2.3 | 300 | 8 | 200 | 3/60 | Good |
| Example 3 | CSZT | Present | 87 | 97 | Higher | 3.2 | 1.4 | 2.3 | 300 | 8 | 200 | 0/60 | Good |
| Example 15 | CSZT | Present | 93 | 98 | Higher | 3.2 | 1.4 | 2.3 | 300 | 8 | 200 | 4/60 | Good |
| Example 16 | CSZT | Present | 81 | 82 | Higher | 3.2 | 1.4 | 2.3 | 300 | 8 | 200 | 2/60 | Good |
| Example 3 | CSZT | Present | 87 | 97 | Higher | 3.2 | 1.4 | 2.3 | 300 | 8 | 200 | 0/60 | Good |
| Example 17 | CSZT | Present | 85 | 103 | Higher | 3.2 | 1.4 | 2.3 | 300 | 8 | 200 | 1/60 | Good |
| Example 3 | CSZT | Present | 87 | 97 | Higher | 3.2 | 1.4 | 2.3 | 300 | 8 | 200 | 0/60 | Good |
| Example 18 | BT | Present | 84 | 99 | Higher | 3.2 | 1.4 | 2.3 | 300 | 8 | 200 | 0/60 | Good |

Examples 1 to 5 were carried out under the same conditions except that the Mn content of the dielectric paste for the Mn-rich sheets was changed. In Example 6, no Mn-rich sheets were used, and the Mn-adequate sheets were used instead.

In each of Examples 1 to 6, the external dielectric layers had a Mn concentration gradient increasing from the vicinity of the first internal electrode layer outwards along the lamination direction. Moreover, the average intensity of the characteristic X-ray of Mn of the portion away from the first internal electrode layer by 1 μm or more and 50 μm or less was 80% or more and 90% or less of the average intensity of the characteristic X-ray of Mn of the portion away from the first internal electrode layer by 100 μm or more and 200 μm or less, and the average intensity of the characteristic X-ray of Mn of the portion away from the first internal electrode layer by 50 μm or more and 100 μm or less was 90% or more and 100% or less of the average intensity of the characteristic X-ray of Mn of the portion away from the first internal electrode layer by 100 μm or more and 200 μm or less.

In Examples 1 to 5, the Mn concentration of the first internal electrode layer was higher than that of other internal electrode layers. In contrast, in Example 6, the Mn concentration of the first internal electrode layer and that of the other internal electrode layers were the same. Thus, the results of the thermal crack test of Examples 1 to 5 were better than those of Example 6. It was confirmed that, in Examples 1 to 5 and other examples described later, the internal electrode layers (e.g., first internal electrode layer) included the Mn segregates, and the first internal electrode layer included more Mn segregates. In contrast, in Example 6, all the internal electrode layers had the same percentage of the Mn segregates.

In particular, in Examples 2 to 4, in which C1/C3 was 2.5 or more and 4.0 or less, C1/C2A was 1.2 or more and 2.0 or less, and C2A/C2B was 1.5 or more and 3.0 or less, the results of the thermal crack test were best.

In Example 1, in which C1/C3, C2A/C2B, and C1/C2A were high, the temperature characteristics were worse than those of Examples 2 to 6.

Examples 7 to 9 were carried out as in Example 3 except that the thickness of the external dielectric layers was changed and, in response to that, the size of the multilayer ceramic capacitors in the lamination direction was changed. In Examples 3 and 7 to 9, the results of the thermal crack test and the temperature characteristics were both good.

In particular, in Examples 3, 7, and 8, in which the thickness of the external dielectric layers was 150 μm or more and 500 μm or less, the results of the thermal crack test were better than those of Example 9, in which the thickness of the external dielectric layers was 550 μm.

Examples 10 and 11 were carried out as in Example 3 except that the thickness of the internal dielectric layers was changed and, in response to that, the size of the multilayer ceramic capacitors in the lamination direction was changed. In Examples 3, 10, and 11, the results of the thermal crack test and the temperature characteristics were both good.

Examples 12 and 13 were carried out as in Example 3 except that the number of the internal electrode layers was changed and, in response to that, the number of the internal dielectric layers and the size of the multilayer ceramic capacitors in the lamination direction were changed. In Examples 3, 12, and 13, the results of the thermal crack test and the temperature characteristics were both good.

Examples 14 to 17 were carried out as in Example 3 except that the Mn concentration gradient of the external dielectric layers was changed. Specifically, the arrangement of the no-Mn sheets was appropriately changed to change the Mn concentration gradient.

In Examples 3 and 14 to 17, the results of the thermal crack test and the temperature characteristics were both good. However, in all of Example 14, in which the average intensity of the characteristic X-ray of Mn of the portion away from the first internal electrode layer by 1 μm or more and 50 μm or less was low; Example 15, in which the average intensity of the characteristic X-ray of Mn of the portion away from the first internal electrode layer by 1 μm or more and 50 μm or less was high; Example 16, in which the average intensity of the characteristic X-ray of Mn of the portion away from the first internal electrode layer by 50 μm or more and 100 μm or less was low; and Example 17, in which the average intensity of the characteristic X-ray of Mn of the portion away from the first internal electrode layer by 50 μm or more and 100 μm or less was high, thermal cracks were generated more readily than in Example 3.

Example 18 was carried out as in Example 3 except that the perovskite compound was changed to BaTiO₃ (abbreviated to “BT” in Table 1). In Examples 3 and 18, the results of the thermal crack test and the temperature characteristics were both good.

### REFERENCE NUMERALS

1, 1a, 1b . . . multilayer ceramic capacitor
2 . . . dielectric layer
2a . . . external dielectric layer
2b . . . internal dielectric layer
3 . . . internal electrode layer
3a . . . first internal electrode layer
3b1 . . . gap-corresponding portion of second internal electrode layer
3b2 . . . portion other than gap-corresponding portion of second internal electrode layer
3c . . . third internal electrode layer
4 . . . external electrode
10 . . . element body
11 . . . . Mn segregate
21 . . . . Mn-rich sheet
22 . . . . Mn-adequate sheet
23 . . . no-Mn sheet
31 . . . internal electrode pattern

What is claimed is:

1. A multilayer ceramic electronic device comprising:
dielectric layers and internal electrode layers, the dielectric layers and the internal electrode layers being laminated,
wherein
the internal electrode layers comprise a first internal electrode layer located farthest out along a lamination direction;
the dielectric layers comprise an external dielectric layer located outwards from the first internal electrode layer along the lamination direction; and
the external dielectric layer has a concentration gradient of Mn increasing from a vicinity of the first internal electrode layer outwards along the lamination direction.

2. The multilayer ceramic electronic device according to claim 1, wherein the external dielectric layer has a thickness of 150 μm or more and 500 μm or less.

3. The multilayer ceramic electronic device according to claim 2, wherein
the external dielectric layer comprises a portion away from the first internal electrode layer by not more than 100 μm; and
the portion has the concentration gradient.

4. The multilayer ceramic electronic device according to claim 3, wherein
the external dielectric layer comprises a portion away from the first internal electrode layer by 100 μm or more, a portion away from the first internal electrode layer by 1 μm or more and 50 μm or less, and a portion away from the first internal electrode layer by 50 μm or more and 100 μm or less;
the portion away from the first internal electrode layer by 1 μm or more and 50 μm or less has a Mn concentration that is 80% or more and 90% or less of a Mn concentration of the portion away from the first internal electrode layer by 100 μm or more; and
the portion away from the first internal electrode layer by 50 μm or more and 100 μm or less has a Mn concentration that is 90% or more and 100% or less of the Mn concentration of the portion away from the first internal electrode layer by 100 μm or more.

5. The multilayer ceramic electronic device according to claim 1, wherein the first internal electrode layer has a Mn concentration higher than that of other internal electrode layers.

6. The multilayer ceramic electronic device according to claim 5, wherein the internal electrode layers comprise a second internal electrode layer being located inwards from the first internal electrode layer and having a gap-corresponding portion;
the internal electrode layers comprise a third internal electrode layer being located inwards from the second internal electrode layer and not having the gap-corresponding portion; and
C3<C2A<C1 is satisfied, where
C1 denotes the Mn concentration of the first internal electrode layer,
C2A denotes a Mn concentration of the gap-corresponding portion of the second internal electrode layer, and
C3 denotes a Mn concentration of the third internal electrode layer.

7. The multilayer ceramic electronic device according to claim 6, wherein C1/C3 is 2.5 or more and 4.0 or less.

8. The multilayer ceramic electronic device according to claim 6, wherein C2A/C2B is 1.5 or more and 3.0 or less, where C2B denotes a Mn concentration of a portion of the second internal electrode layer other than the gap-corresponding portion.

9. The multilayer ceramic electronic device according to claim 6, wherein C1/C2A is 1.2 or more and 2.0 or less.

10. The multilayer ceramic electronic device according to claim 1, wherein
the dielectric layers comprise an internal dielectric layer located inwards from the first internal electrode layer along the lamination direction; and
the internal dielectric layer has a thickness of 3.0 μm or more and 15 μm or less.

11. The multilayer ceramic electronic device according to claim 1, wherein the number of the internal electrode layers is 50 or more and 300 or less.

12. The multilayer ceramic electronic device according to claim 1, wherein the dielectric layers comprise Ca, Sr, Zr, Ti, and O.
